(19) United States
(12) Patent Application Publication
(10) Pub. No.: US 2021/0109896 A1
(43) Pub. Date: Apr. 15, 2021

(54) Smart Filesystem Indexing For Any Point-in-Time Replication

(71) Applicant: EMC IP Holding Company LLC, Hopkinton, MA (US)

(72) Inventors: Jehuda Shemer, Kfar Saba (IL); Alex Solan, Tel Aviv (IL)

(73) Assignee: EMC IP Holding Company, LLC, Hopkinton, MA (US)

(21) Appl. No.: 16/599,531

(22) Filed: Oct. 11, 2019

(51) Int. Cl. G06F 16/178; G06F 16/13; G06F 16/11; G06F 16/17; G06F 16/16; G06F 11/14

(52) U.S. Cl. CPC G06F 16/178; G06F 16/13; G06F 16/128; G06F 16/1734; G06F 2201/84; G06F 11/1451; G06F 11/1471; G06F 2201/80; G06F 16/168

(57) ABSTRACT

Filesystem events that change a file system are detected, and information comprising metadata that describe each filesystem change event of a consecutive sequence of changes is created and associated with timestamps and point-in-time snapshots of the filesystem at the time of occurrence of the filesystem events. The information is entered into an event stream that is saved in a journal, and applied to a previously created full index of the filesystem structure in the journal to synthesize and replicate a filesystem index and structure as they existed at any desired point in time represented by the event stream. The reconstructed index and filesystem structure can be searched for a reference to an object of interest such as a filename or a directory, and the file or directory recovered and replicated using an associated PiT.

### BACKGROUND

Computer data storage systems typically have a need to protect stored data to permit recovery of the data in the event of a disaster, and may employ various data protection approaches for this purpose. One such approach is data backup, where backup copies (discrete static images) of a data storage volume are saved periodically, e.g., weekly, daily, or hourly to enable recovery of backed up data following a crash. While traditional data backup may permit the data to be recovered to a particular point in time at which a backup copy was made, a disadvantage of traditional backup is that it does not permit recovery of any intermediate changes to the data that were made between the backup copy and the crash or for that matter between backup copies, and does not enable recovery and replication of the system to any desired point in time. In some enterprise storage systems such as transactional processing, banking or military applications any loss of data can be disastrous, and it is frequently desirable to replicate the state of the filesystem as it existed at any particular point in time. Accordingly, a common practice in the industry is to use indexing on a filesystem to afford a view of the general filesystem hierarchy. In backup systems, filesystem indexing may be performed for periodic snapshot images so that a user may inspect the filesystem at the different snapshots without full recovery of a volume or a virtual machine (VM), which is time consuming and expensive.

Continuous data protection (CDP), also known as continuous backup, is an approach that backs up computer data by automatically saving a copy of every change made to that data at a block level. This typically requires asynchronously copying data changes to a second location, which imposes additional resource requirements and overhead for additional disk write operations, but it avoids the need for scheduled backups. CDP systems create numerous point-in-time images (“PiTs”) and information about data changes, so theoretically CDP allows restoration of data to any incremental point in time at which data changes occurred. However, both traditional backup and continuous backup systems operate at the block level; and neither is designed to provide a list of specific data or filesystem changes that facilitate “any point-in-time” recovery and replication either of lost or corrupted data of interest or of the filesystem.

Dell EMC RecoverPoint technology is a journal-based product offering of the assignee of this invention that provides continuous data protection for storage arrays running on a dedicated RecoverPoint Appliance (RPA). The RecoverPoint technology enables protection of data at local and remote locations, and it provides bi-directional replication and any point-in-time recovery of data. RecoverPoint facilitates restoration of the system, not just particular data.

A disadvantage to a user of an any point-in-time replication system is that such systems create a large number of PiT images (snapshots), and users do not have convenient visibility into the contents of these PiT images because of the lack of an index to identify either the filesystem structure or an appropriate PiT image that contains data of interest at any desired point in time (“any PiT”). In order to search a PiT image to determine if it contains a particular data change or filesystem state of interest, the PiT image must be mounted to view it to determine whether it contains the change or state of interest, which is very time consuming. This makes it difficult to easily locate a particular desired PiT that includes data of interest. Moreover, traditional filesystem indexing of PiT images is impractical because it takes too long. Creating a filesystem index may take several seconds or several minutes to complete, whereas a PiT image may be created every few input/outputs (I/Os), and there may be hundreds or thousands of I/Os created every second. Thus, it is impractical to create an index of every filesystem change. Periodically indexing of PiTs is too granular and inaccurate to enable either a filesystem structure or a particular data file of interest to be identified and replicated, and is additionally impractical to implement. Thus, existing indexing systems are not sufficient for any PiT replication and recovery of either a filesystem or a data file at any point in time.

There is a need to address these and other issues associated with point-in-time replication by providing systems and methods that afford effective and easy visibility into and searching of PiTs created during the operation of a CDP system to enable PiTs containing changes of interest to be quickly located to permit replication of the filesystem structure and data recovery at any point in time. The invention affords a system and method that address these and other issues associated with RecoverPoint CDP systems and the like, and that avoid the foregoing problems.

### BRIEF DESCRIPTION OF THE DRAWINGS

FIG. 1 is functional block diagram of an embodiment of an any point-in-time replication system in accordance with the invention;

FIG. 2 is functional block diagram that gives an overview of the function of the system of FIG. 1;

FIG. 3A is a diagrammatic view at a first time of a full index and filesystem structure of a filesystem in accordance with the invention, and FIG. 3B is a diagrammatic view of a exemplary filesystem event stream of changes that may be applied to the index structure of FIG. 3A;

FIG. 4A is a diagrammatic view of another full index and filesystem structure of the filesystem of FIG. 3A at a second later time after applying the changes, and FIG. 4B is a another view of the filesystem event stream of FIG. 3B;

FIG. 5A is a diagrammatic view of a third full index and filesystem structure of the filesystem of FIG. 3A at a third later time after applying the exemplary changes shown in the filesystem event stream shown in FIG. 5B; and

FIG. 6 is a diagrammatic view of a work flow indexing process in accordance with the invention.

### DESCRIPTION OF PREFERRED EMBODIMENTS

The invention is particularly well adapted for use with RecoverPoint continuous data protection (CDP) systems of Dell EMC, the assignee of this invention, for any point-in-time recovery, and will be described in that context. However, it will be appreciated from the description that follows that the invention may also be used effectively with other types of replication/recovery systems.

Dell EMC RecoverPoint technology, a journal based offering of the assignee of this invention, provides continuous data protection for any point-in-time recovery. RecoverPoint CDP employs a RecoverPoint Appliance (RPA) that tracks all changes to data at the input/output (I/O) or block level, and journals these changes as a sequence of consecutive events. In contrast to backup systems, which store only static and periodic discrete changes to data, with RecoverPoint CDP every I/O event that changes data such as a data write to a file is tracked and stored in a journal as a different PiT snapshot of the data drive. This allows restoration of data to any I/O or PiT. If a data block or a data file is corrupted or lost, the journal allows rolling the data back to a previous point-in-time to view the data state of the data drive as it existed previously prior to loss or corruption, and enables recovery and replication of the data locally as well as remotely at a recovery site. RecoverPoint also enables rolling forward from a selected PiT to view subsequent data changes from that selected PiT. While journaling replication systems such as RecoverPoint capture several million points in time each day, they do not afford convenient and quick visibility into the structure of a filesystem or the contents of PiT images, so locating a particular change or a particular data file at any desired point in time, for example, can be challenging and time consuming.

This invention is related to and may use some of the same methods and systems disclosed in commonly-owned co-pending application Ser. No. 16/558,606 of the same inventors, filed Sep. 3, 2019, the disclosure of which is incorporated by reference herein.

As will be described below in detail, the invention provides a system and method which capture an event stream of consecutive filesystem changes occurring to a filesystem and corresponding PiT snapshot images of the filesystem data state at the time of occurrence of each change event, and use these filesystem events and snapshots and a previously saved full index of the filesystem to create a full index and recreate the filesystem structure as it existed at a previous point in time. The PiT snapshots corresponding to the filesystem events can be used to recover and replicate desired data as it existed at the time of occurrence of a filesystem event. The filesystem event stream of the invention may include metadata comprising a timestamp and a description of each filesystem event to enable creation of an index that describes the filesystem structure at the time of occurrence, and a PiT snapshot detailing the data state (content) of the filesystem. The system and method of the invention save this information as an event stream of metadata in a journal. The metadata descriptions of filesystem events comprise descriptive text strings which describe the filesystem level changes to the system, and afford comprehensible understanding, insight and cues into associated data and system structural changes. The index and metadata afford convenient visibility into and easy searching of the journal of filesystem events to locate a data change involving the filename of a file or other data of interest. Once located, the structure of the filesystem may be replicated and associated PiT snapshots and metadata may be used to recover and replicate the desired file or data. As will be described, the filesystem event stream represents changes to the structure and content of the filesystem at different points in time, and allows replication of the filesystem to a desired PiT rolling either forward or backward in time from the full index.

As used herein, and as well understood by those skilled in the art, the term filesystem (FS) refers to an organization and data structure that controls how pieces or groups of data are stored and retrieved. A filesystem keeps track of where data is located in a storage device. It refers to the logic and structure used to manage groups of data (objects) such as files or directories. Without a filesystem, information placed in a storage medium would be one large body of data with no way to tell where one piece of information ends and the next begins. The term “file” refers to a group or piece of data, i.e., “data file”, in a filesystem, and is typically accessed by a filename and a path to a directory (or folder) in the filesystem where it is located. There are differences between filesystem events and file or block level events. The term “filesystem event” as understood by those skilled in the art and used herein refers to operations at the filesystem level that change the structure and organization of a filesystem, such as, for example, the following: Create File; Remove File; Move File; Create Directory; Remove Directory; Open File for Write/Modify; and Close File. File or block level operations on the other hand are those changes that occur on a file level to a file itself, such as, for example, the following: Read File; Write File; Copy File; Delete File, Move File, etc. The term “metadata” as used herein with reference to a file refers to bookkeeping and descriptive information about the file, such as, for instance, the length of the data contained in the file, e.g., the number of blocks or the byte count, a timestamp indicating the date and time the file was created or modified, the file device type, the file's users or group ID, its access permissions, changes to the file, and other file attributes such as whether a file is read-only, an executable, etc. In relation to a filesystem event, “metadata” refers to descriptive information about a change to the filesystem, such as the object changed, the type of change, the time of the change, etc.

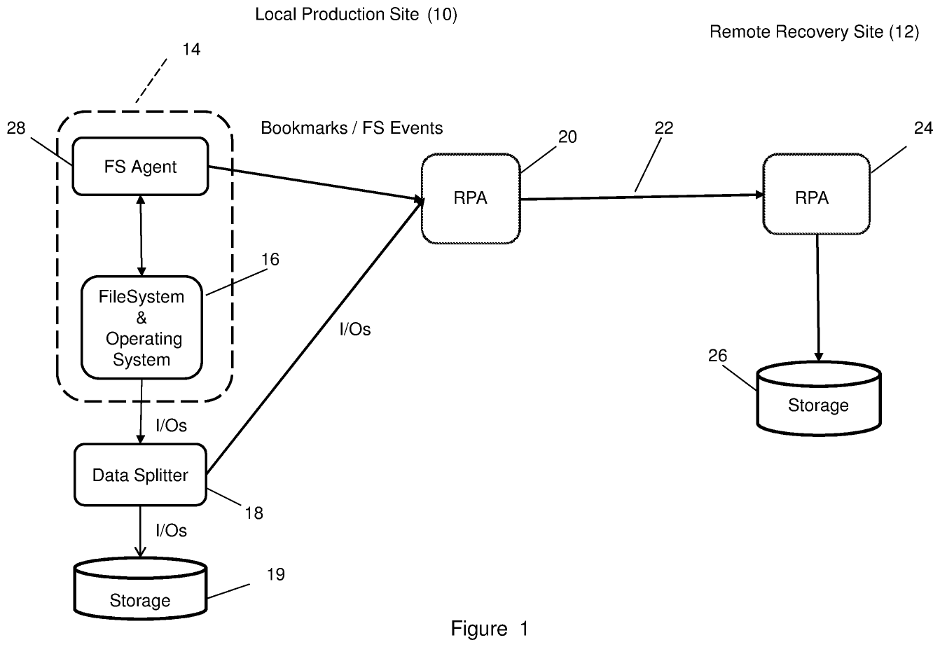

Referring to FIG. 1, the figure illustrates a functional block diagram of a system in accordance with a preferred embodiment of the invention. In an embodiment, the invention preferably comprises a modification and enhancement to a RecoverPoint system that employs continuous data change monitoring at a local production site 10 and replication and recovery at a recovery site 12. The system of FIG. 1 may comprise, for instance, the Dell EMC RecoverPoint for Virtual Machines implementation that enables concurrent local and remote data replication with continuous data protection for recovery to any point-in-time (any PiT).

The standard local production site 10 may comprise a production processor 14 such as virtual machine (VM), as from VMware, for example, having an associated filesystem (FS) and operating system (OS) 16. The production site processor 14 may also have associated physical media (not shown) storing computer executable instructions for controlling the processor to perform operations as described herein. The production site processor may further have an associated I/O data splitter 18 that is adapted to split off block I/O changes being made to data in a storage device 19, and to provide the changes to a local cluster of one or more RecoverPoint Appliances (RPAs) 20.

Each RPA of the local cluster may comprise a special purpose appliance that includes a processor and associated memory storing executable instructions for controlling the processor and that manages virtual machines and virtual volumes (not shown). The RPA 20 of the local site 10 may be connected as via a fibre channel (FC) or Ethernet (EN) TCP/IP connection 22 to a remote cluster of RPAs 24 at the recovery site 12. The RPAs 20 and 24 may be substantially the same, and they may manage similar SANs. The RPAs 24 at the recovery site may also be connected to a journal 26 into which information is stored about I/O block level and, as will be described ongoing filesystem changes, at the local site 10, which information is transferred by RPA 20 over network 22 to RPA 24 for storage in journal 26. This information about changes may comprise timestamps, other metadata and PiT images. The journal is a source of information about all changes to the data and the filesystem from a predetermined point in time that, as will be described, that enable recovery, reconstruction and replication of the filesystem structure and data state (content) at any desired point in time.

As may be appreciated, the recovery site 12 may be geographically remote from the local production site 10 or, alternatively, may be co-located with the local production site in the same data center, for instance. Moreover, the recovery site may be adapted to receive information streams from multiple production sites, and to recover and replicate filesystems, files or data of interest in different locations.

The system of FIG. 1, as described so far above, is substantially the Dell EMC RecoverPoint CDP system, before enhancement in accordance with the invention. In accordance with an embodiment of the invention, a standard Dell EMC RecoverPoint system is enhanced, in one aspect, by the addition of a filesystem (FS) event splitter 28, also referred to herein as a filesystem (or FS) agent. The FS agent (splitter) may comprise executable instructions that run on the operating system (OS) of the local production VM processor 14. The FS agent is formed and adapted to automatically detect all operations on the filesystem 16 corresponding to filesystem (FS) events (such as Create File, Remove File, Move File, Create Directory, etc., as previously described) occurring at the filesystem level, and to create comprehensible metadata, including bookmarks, that describe the FS events in user understandable terms. A bookmark is an existing mechanism in RecoverPoint to mark a given PiT. Bookmarks may be associated with a timestamp and a PiT snapshot of the event. The invention associates bookmarks and other metadata with each FS event to form FS event information that characterizes the FS event.

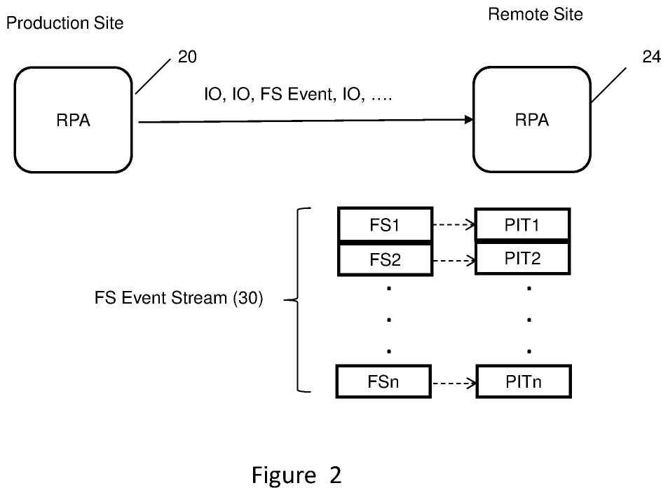

As shown in FIG. 2, this FS event information may be combined in RPA 20, with a stream of I/Os from I/O data splitter 18, FS events and associated metadata from the filesystem agent 28, and transferred as an event stream 30 of consecutive filesystem changes (FS1, FS2 . . . FSn) with corresponding PiT snapshots (PiT1, PiT2 . . . PiTn) to the RPA 24 at the remote recovery site 12 for recording in the journal storage 26. As will be described below, the sequence of FS events in the FS event streams 30, associated metadata and PiT images stored in the journal in combination with a full index of the FS as a reference structure enable recovery and replication of the structure of the FS and the creation of a FS index at any desired point in time, by rolling backwards or forwards in time from the full index and applying the event change entries in the event stream, The associated PiT snapshots enable recovery of files or data states of interest at that particular desired point in time.

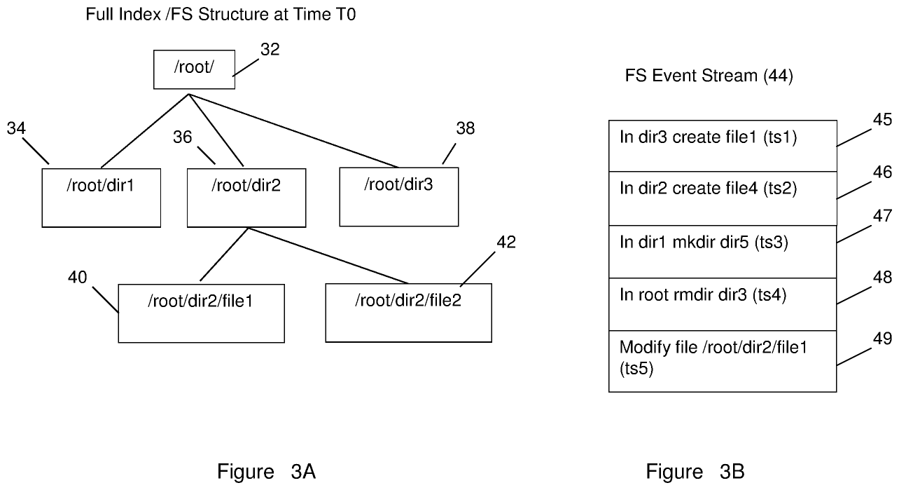

FIGS. 3A-B, 4A-B, and 5A-B comprise diagrammatic views that illustrate the operation of the invention.

Referring to FIGS. 3A-B, FIG. 3A illustrates diagrammatically an example of the structure of a filesystem at a first predetermined time T0. The structure represents a full index of the FS and serves as a reference to the FS structure at predetermined time T0 to which changes are applied to obtain another index and structure at another desired point in time. As shown, the FS structure comprises a root (/root/) 32 and three directories (/root/dir1) 34, (/root/dir2) 36 and (/root/dir3) 38. Each directory may, of course, include sub-directories and files. As shown, dir2 may contain, for example, two files (/root/dir2/file1) 40 and (root/dir2/file2) 42. The FS structure shown in FIG. 3A represents the structure and a full index of the filesystem as it existed at time T0.

FIG. 3B represents, for purposes of illustration, an example of a stream 44 of consecutive filesystem events that may be applied to the file system of FIG. 3A at times indicated by timestamps TS1-TS5 subsequent to time T0. As shown in FIG. 3B, at timestamp TS1, 45, a filet may be created in dir3. At timestamp TS2, 46, subsequent to TS1, a file4 may be created in dir2. Similarly, at timestamps TS3, 47, and TS4, 48, respectively, a new sub directory dir5 may have been created (mkdir) in dirt and dir3 may have been removed (rmdir) from the root; and at TS5, 49, filet at /root/dir2/file1 was modified, as shown.

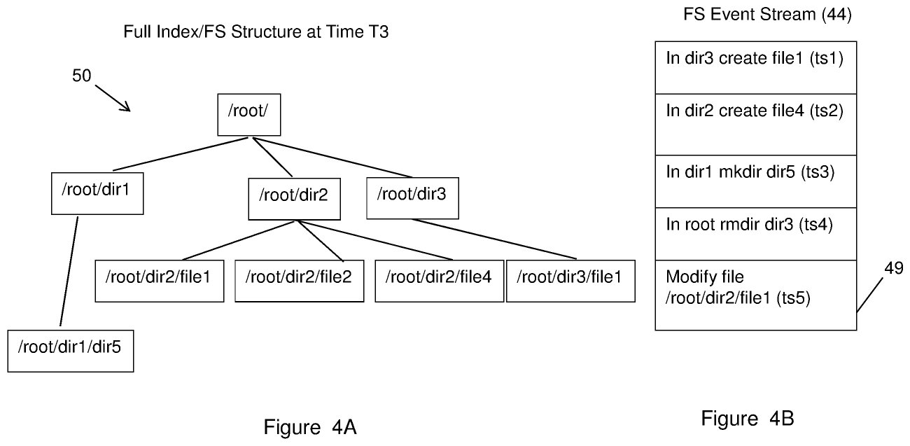

FIG. 4A illustrates diagrammatically the FS structure and corresponding full index 50 of the FS of FIG. 3A at a time T3 after applying the consecutive FS events of the FS event stream 44 shown in FIG. 3B (and repeated in FIG. 4B). As show in FIG. 4A, dir3 (/root/dir3) now has a newly created file, file1 (/root/dir3/file1); dir2 (/root/dir2) has a newly created file, file4; there is a newly created subdirectory, dir5 in subdirectory/root/dir1/; dir3 has been removed from the root; and, finally, file1 in subdirectory/root/dir2 has been modified as indicated in FS event stream 44 at 49.

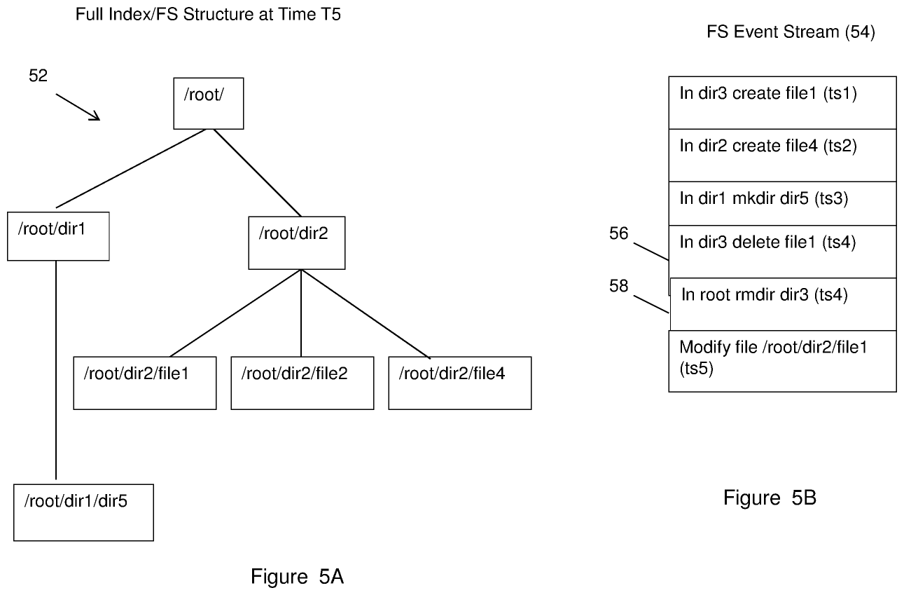

FIG. 5A illustrates diagrammatically the resulting FS structure 52 and corresponding full index of the FS of FIG. 4A after applying the FS changes indicated in the FS event stream 54 shown in FIG. 5B. Event stream 54 is substantially the same as event stream 44, except for entry 56 at TS4. Entry 56 shows that file 1 was deleted from directory dir3 prior to removing the directory as is shown at 58 in FIG. 5B.

The initial full index of FIG. 3A may be a standard full index of the FS. As indicated above, this full index and all subsequent consecutive FS events of the event streams may be stored in a journal, such as in storage 26. The full index serves as a reference for the filesystem structure as it existed initially at a predetermined reference time T0. This permits recovering and replicating a filesystem structure and index as they existed at a desired point in time by rolling forward or backward in time from the full index and applying the sequence of consecutive FS event changes indicated in the event stream entries to the full index between predetermined time T0 and a desired point in time.

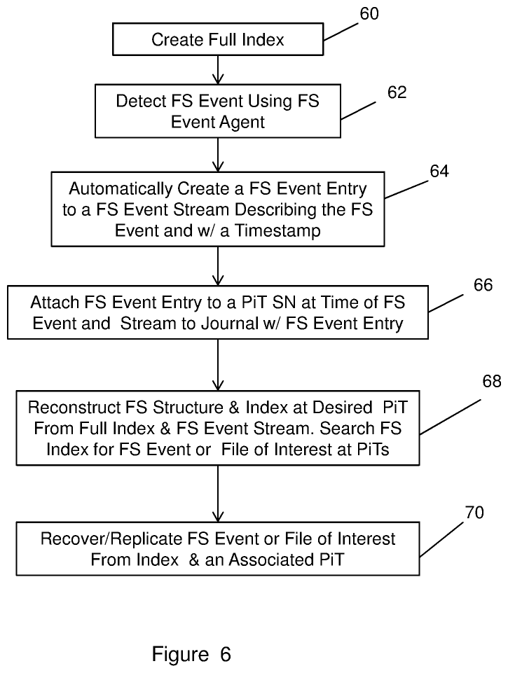

FIG. 6 illustrates a process workflow in accordance with the invention of both indexing and recovery of a filesystem structure and corresponding data content as they existed at a predetermined time. The process operations shown in FIG. 6 may be performed by the processors at the production and/or remote sites and/or the processors in the RPAs 20 and 24.

Referring to FIG. 6, at 60, a standard full index of the filesystem may be created using known approaches. At 62, the FS agent 28 may detect a filesystem event occurring in the production processor 14, and at 64 the FS agent may automatically create information including metadata about the filesystem event upon its occurrence. The metadata preferably comprises, in an embodiment, a comprehensible description of the FS event in understandable terms, to include the object (file or directory) that was changed, the change operation, e.g., make directory (mkdir), open a file, close a file, remove a file or directory, etc., a timestamp of the date and time at which the FS event occurred. At 66, this information may be attached to a PiT snapshot (SN) of the filesystem at the time of occurrence of the FS event, sent to the local RPA 20, and streamed as an event stream to RPA 24 and the journal 26. At 66, the RPA 20 may also receive information describing a file level I/O event, along with associated metadata and a PiT snapshot from data splitter 18, and stream this information also with FS events to RPA 24 for storage in journal 26. This process may be repeated for each subsequent FS change to provide a stream of a sequence of FS change entries for storage in the journal.

Continuing with FIG. 6, at 68 when it is desired to recover or to replicate a file of interest or to recreate the filesystem structure as it existed at a particular point in time, the stored information in the journal comprising the full filesystem reference index and the sequence of consecutive filesystem events may be used to synthesize and reconstruct the filesystem structure and index as they existed at the particular point in time. The sequence of events in the event stream may be applied to the full reference index to replicate the filesystem structure and index as they existed at the desired point in time. The reconstructed filesystem structure and index may be queried and searched at 70 for a desired object (file or directory), as well as any changes to the file or directory over time. An appropriate PiT that contains an image of the object of interest may be retrieved and used to recover the object of interest.

The invention enables the journal to be quickly and easily searched to identify and select an appropriate PiT for recovering and replicating a lost or corrupted object or a data state at a particular time. The invention may also be used advantageously to afford a history of the filesystem changes as for analysis or diagnosis of problems, in addition to aiding in the discovery of an appropriate PiT image for locating an object of interest. Selecting a PiT image just before a file was deleted or modified, or just after the file was closed, for example, is a good point in time to restore the file. Similarly, a PiT before a directory was created, removed or renamed may be selected as appropriate to restore and replicate data or a previous data state of the directory. The system and method of the invention makes it possible to replicate and restore a prior data state of a filesystem easily at a desired time.

As will be appreciated from the foregoing, by providing a FS event splitter to detect FS events and creating a sequence of bookmarks and metadata that describe the events, the invention affords insight and visibility into the contents of PiTs that enable desired data to be quickly and easily located, retrieved and replicated, thereby greatly enhancing the usability of an any PiT continuous data protection system.

While the foregoing has been with reference to particular embodiments of the invention, it may be appreciated that these are merely representative and that changes to these embodiments may be made without departing from the principles of the invention, the scope of which is defined by the appended claims.

1. A method of recovering and replicating a filesystem at a desired point in time in an any point-in-time replication system, comprising:
creating a reference filesystem index that details the structure of a filesystem at a predetermined time;
detecting consecutive filesystem events that change said filesystem;
creating for each said filesystem event information an entry in an event stream comprising a sequence of consecutive filesystem events, each filesystem event information entry detailing a corresponding change to the filesystem made by the filesystem event;
associating each said filesystem event information entry in said event stream with a timestamp and a point-in-time (PiT) snapshot of the filesystem at the time of occurrence of the filesystem event;
streaming said event stream for storage in a journal; and
replicating a filesystem as it existed at a desired point in time by applying in sequence to said reference filesystem index consecutive filesystem events from said journal in order of occurrence between said desired point in time and said predetermined time.

2. The method of claim 1, wherein said replicating said filesystem at a desired point in time comprises applying to said reference filesystem index filesystem changes that occurred after said predetermined time to move forward in time, and applying filesystem changes that occurred before said predetermined time to move backward in time.

3. The method of claim 1 further comprising searching said replicated filesystem for a filesystem object of interest; and selecting a PiT snapshot that contains said object of interest.

4. The method of claim 1, wherein said detecting said filesystem event comprises detecting filesystem level changes using an agent executing on a processor at a production site, and said creating said filesystem event information comprises creating said information to identify the object changed and the change operation.

5. The method of claim 4, wherein said creating said information comprises creating said information as a descriptive string to be user understandable.

6. The method of claim 4, wherein said detecting a file system event comprises detecting an operation in a processor at a data production site that causes a filesystem level change to said filesystem, and said creating said filesystem event information entry comprises translating said operation into a user understandable text string description of said filesystem level change.

7. The method of claim 1 further comprising selecting a PiT snapshot for a time at which said filesystem was in a state prior to a filesystem object of interest being lost or corrupted to recover said filesystem object of interest.

8. The method of claim 7, wherein said filesystem object of interest comprises an object as it existed at a time prior to the object being lost or corrupted, and the method further comprises selecting a PiT snapshot for a time before said prior time.

9. The method of claim 1 further comprising entering into said storage a continuous event stream of filesystem events as said events occur.

10. The method of claim 1 further comprising recovering and replicating an object of interest by identifying a relevant PiT snapshot containing said object of interest using said replicated filesystem.

11. Non-transitory computer readable storage medium embodying executable instructions for controlling a processor to perform a method of recovering and replicating a filesystem at a desired point in time in an any point-in-time replication system, comprising:
creating a reference filesystem index that details the structure of a filesystem at a predetermined time;
detecting consecutive filesystem events that change said filesystem;
creating for each said filesystem event information an entry in an event stream comprising a sequence of consecutive filesystem events, each filesystem event information entry detailing a corresponding change to the filesystem made by the filesystem event;
associating each said filesystem event information entry in said event stream with a timestamp and a point-in-time (PiT) snapshot of the filesystem at the time of occurrence of the filesystem event;
streaming said event stream for storage in a journal; and
replicating a filesystem as it existed at a desired point in time by applying in sequence to said reference filesystem index consecutive filesystem events from said journal in order of occurrence between said desired point in time and said predetermined time.

12. The non-transitory computer readable storage medium of claim 11, wherein said replicating said filesystem at a desired point in time comprises to said reference filesystem index applying filesystem changes that occurred after said predetermined time to move forward in time, and applying filesystem changes that occurred before said predetermined time to move backward in time.

13. The non-transitory computer readable storage medium of claim 11 further comprising identifying and retrieving a PiT snapshot that contains said object of interest by searching said replicated filesystem for said object of interest.

14. The non-transitory computer readable storage medium of claim 11, wherein said detecting said filesystem event comprises detecting filesystem level changes using an agent executing on a processor at a production site, and said creating said filesystem event information comprises creating said information to identify the object changed and the change operation.

15. The non-transitory computer readable storage medium of claim 14, wherein said creating said information comprises creating said information as a descriptive string to be user understandable.

16. The non-transitory computer readable storage medium of claim 14, wherein said detecting a file system event comprises detecting an operation in a processor at a data production site that causes a filesystem level change to said filesystem, and said creating said filesystem event information entry comprises translating said operation into a user understandable text string description of said filesystem level change.

17. The non-transitory computer readable storage medium of claim 11 further comprising selecting a PiT snapshot for a time at which said filesystem was in a state prior to a filesystem object of interest being lost or corrupted to recover said filesystem object of interest.

18. The non-transitory computer readable storage medium of claim 17, wherein said filesystem object of interest comprises an object as it existed at a time prior to the object being lost or corrupted, and the method further comprises selecting a PiT snapshot for a time before said prior time.

19. The non-transitory computer readable storage medium of claim 11 further comprising entering into said storage a continuous event stream of filesystem events as said events occur.

20. The non-transitory computer readable storage medium of claim 11 further comprising recovering and replicating an object of interest by identifying a relevant PiT snapshot containing said object of interest using said replicated filesystem.
